(19) United States
(12) Patent Application Publication
(10) Pub. No.: US 2026/0301054 A1
(43) Pub. Date: Oct. 1, 2026

(54) DIGITAL PROMOTION PROCESSING SYSTEM BASED UPON MATCHED INFLUENCER-SHOPPER AND RELATED METHODS

(71) Applicant: Inmar Brand Solutions, Inc., Winston-Salem, NC (US)

(72) Inventors: Leah LOGAN, Bentonville, AR (US); Jeffery HAYES, Seattle, WA (US); Christopher J. HENRY, Chicago, IL (US); Anand Milind KULKARNI, Oakville (CA); Michael K. DELANEY, Revere, MA (US); Sarah MARTIN, Portland, OR (US); Christopher BACK, Cincinnati, OH (US)

(21) Appl. No.: 19/573,094

(22) Filed: Mar. 20, 2026

Related U.S. Application Data
(60) Provisional application No. 63/777,622, filed on Mar. 25, 2025.

(51) Int. Cl. G06Q 30/0601

(52) U.S. Cl. CPC G06Q 30/06312

(57) ABSTRACT

A digital promotion processing system may include shopper devices and a digital promotion processing server. The server may determine first unique identifiers from social media content for associated followers, and store purchase histories associated with shoppers. Each purchase history may have a second unique identifier associated therewith. The server may, for each influencer, match respective followers to corresponding shoppers by determining matching first and second unique identifiers, obtain respective purchase histories for each follower-shopper, and generate a commerce fit score for a given product category for purchase based upon a number of matching first and second unique identifiers and the obtained respective product purchase histories. The server may also generate a digital promotion for the given product category for purchase, and communicate the digital promotion to shopper devices associated with the shoppers that are also followers of a corresponding influencer based upon the commerce fit score.

### RELATED APPLICATIONS

The present application claims the priority benefit of provisional application Ser. No. 63/777,622 filed on Mar. 25, 2025, the entire contents of which are herein incorporated by reference.

### TECHNICAL FIELD

The present invention relates to the field of digital promotion processing, and, more particularly, to generating a digital promotion for matched influencer-shoppers, and related methods.

### BACKGROUND

Sales of a particular product or service may be based upon how well that product or service is marketed to a consumer. One form of marketing is called influencer marketing. Influencer marketing enables a brand, for example, to connect with potential customers.

In many instances, a consumer may trust an influencer over other types of content, for example, brand content. An influencer may address the shortcomings of brand content or a typical marketing campaign by using the influencer's media reach to educate consumers on the given product and/or provide positive feedback about the given product.

An influencer, for example, may generate content for more than one brand. An influencer may also provide feedback in the form of a review that may not be helpful to a particular brand or marketing campaign. Even still further, an influencer may have previously provided content about a sensitive topic (e.g., political) unrelated to brand content or a marketing campaign.

Another form of marketing or promotion is a coupon, typically in paper form, for a discount toward the product or service. Some coupons may be retailer specific, for example, only redeemable for the discount at a particular retailer, while other coupons may be product specific from a manufacturer and redeemable at any retailer.

### SUMMARY

A digital promotion processing system may include a plurality of shopper devices, and a digital promotion processing server. The digital promotion processing server may be configured to determine a plurality of first unique identifiers from social media content for followers associated with a plurality of social media influencers and store a plurality of product purchase histories associated with a plurality of shoppers. Each product purchase history may have a second unique identifier associated therewith. The digital promotion processing server may be configured to, for each social media influencer of the plurality thereof, match respective followers to corresponding shoppers by determining matching first and second unique identifiers, obtain respective product purchase histories for each matched follower-shopper based upon the matched first and second unique identifier pair, and generate a commerce fit score for a given product category for purchase based upon a number of matching first and second unique identifiers and the obtained respective product purchase histories. The digital promotion processing server may also be configured to generate a digital promotion for the given product category for purchase and communicate the digital promotion to corresponding ones of the plurality of shopper devices associated with the shoppers that are also followers of a corresponding social media influencer based upon the commerce fit score.

Each obtained product purchase history may include a number of shopping trips for the corresponding shopper. The promotion processing server may be configured to generate the commerce fit score, for each social media influencer, based upon at least one of a total number of shopping trips among the matched follower-shoppers, and a number of shopping trips per matched follower-shopper, for example.

Each obtained product purchase history may include a sales-per-trip for the corresponding shopper. The digital promotion processing server may be configured to generate the commerce fit score, for each influencer, based upon the sales-per-trip of each matched follower-shopper, for example.

The digital promotion processing server may be configured to generate the commerce fit score to represent a propensity of followers of the social media influencer to purchase a product in the given product category, for example. The digital promotion processing server may be configured to generate the commerce fit score for the given social media influencer based upon a baseline comparison of followers of the influencer to a general population and other social media influencers from among the plurality thereof.

The digital promotion processing server may be configured to generate the commerce fit score based upon a purchase cycle length for the given product category, for example. The digital promotion processing server may be configured to generate the commerce fit score based upon sales of products in the given product category.

The first unique identifier may include at least one of a social media username, an email address, and a phone number, for example. The second unique identifier may include at least one of a username associated with a retail loyalty program, an email address, and a phone number, for example.

A method aspect is directed to a method of processing a digital promotion. The method may include using a digital promotion processing server to determine a plurality of first unique identifiers from social media content for followers associated with a plurality of social media influencers, and store a plurality of product purchase histories associated with a plurality of shoppers. Each product purchase history may have second unique identifier associated therewith.

The method may also include using the digital promotion processing server to for each social media influencer of the plurality thereof, match respective followers to corresponding shoppers by determining matching first and second unique identifiers, obtain respective product purchase histories for each matched follower-shopper based upon the matched first and second unique identifier pair, and generate a commerce fit score for a given product category for purchase based upon a number of matching first and second unique identifiers and the obtained respective product purchase histories. The method may further include using the digital promotion processing server to generate a digital promotion for the given product category for purchase, and communicate the digital promotion to corresponding ones of a plurality of shopper devices associated with the shoppers that are also followers of a corresponding social media influencer based upon the commerce fit score.

A computer readable medium aspect is directed to a non-transitory computer readable medium for processing a digital promotion. The non-transitory computer readable medium includes computer executable instructions that when executed by a processor cause the processor to perform operations. The operations may include determining a plurality of first unique identifiers from social media content for followers associated with a plurality of social media influencers, and storing a plurality of product purchase histories associated with a plurality of shoppers. Each product purchase history may have second unique identifier associated therewith.

The operations may include, for each social media influencer of the plurality thereof, matching respective followers to corresponding shoppers by determining matching first and second unique identifiers, obtaining respective product purchase histories for each matched follower-shopper based upon the matched first and second unique identifier pair, and generating a commerce fit score for a given product category for purchase based upon a number of matching first and second unique identifiers and the obtained respective product purchase histories. The operations may also include generating a digital promotion for the given product category for purchase, and communicating the digital promotion to corresponding ones of a plurality of shopper devices associated with the shoppers that are also followers of a corresponding social media influencer based upon the commerce fit score.

### BRIEF DESCRIPTION OF THE DRAWINGS

FIG. 1 is a schematic diagram of a digital promotion processing system in accordance with an embodiment.

FIG. 2 is a schematic operational diagram of the digital promotion processing server of FIG. 1.

FIG. 3 is another schematic operational diagram of the digital promotion processing server of FIG. 1.

FIG. 4 is a schematic block diagram of a digital promotion processing server of FIG. 1.

FIG. 5 is a flow chart illustrating operation of the digital promotion processing server of FIG. 1.

FIG. 6 is a diagram illustrating conceptual operation of the digital promotion processing system of FIG. 1.

FIG. 7 is a schematic diagram of a digital promotion processing server in accordance with another embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

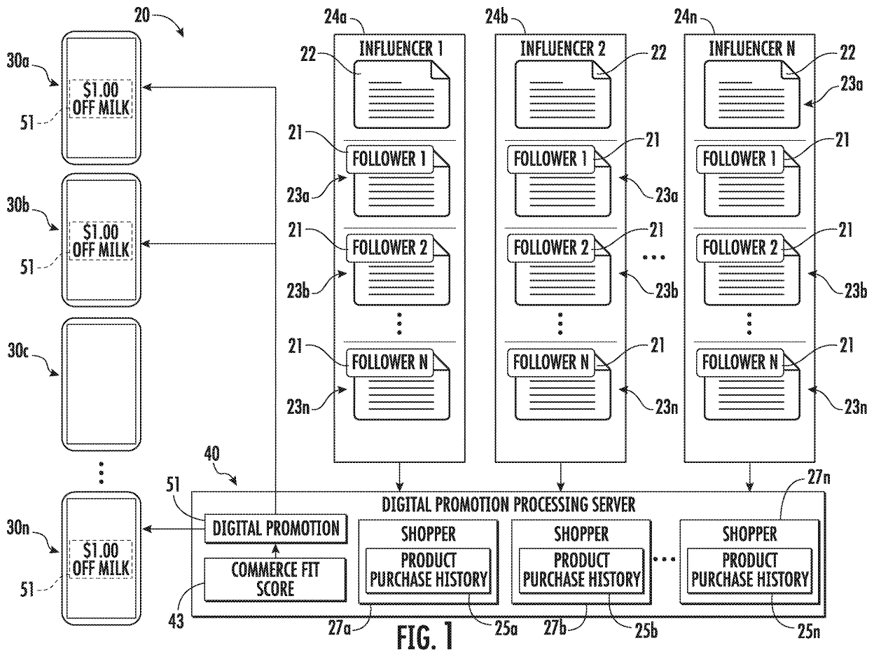

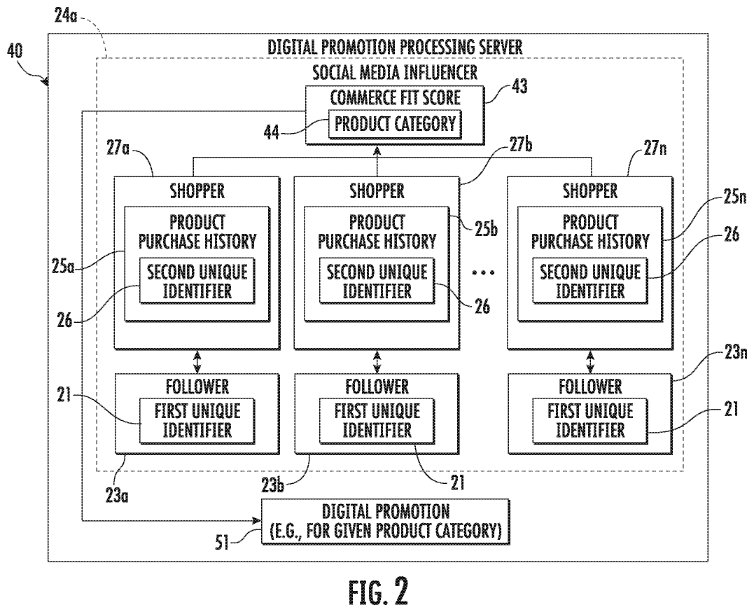

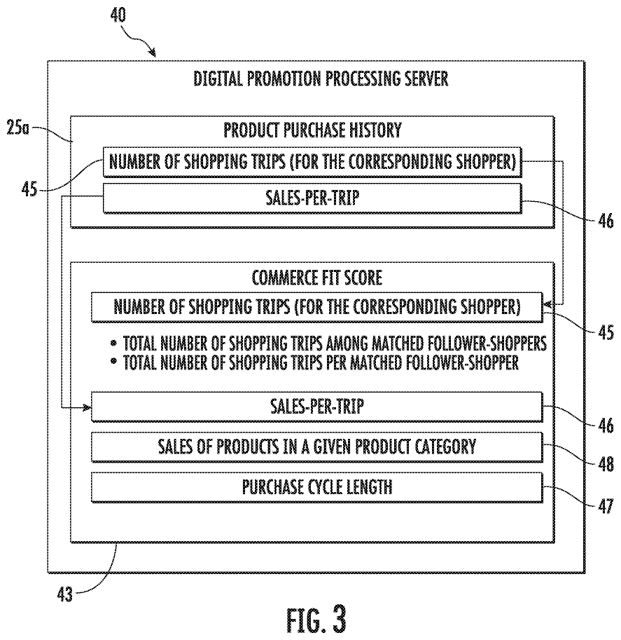

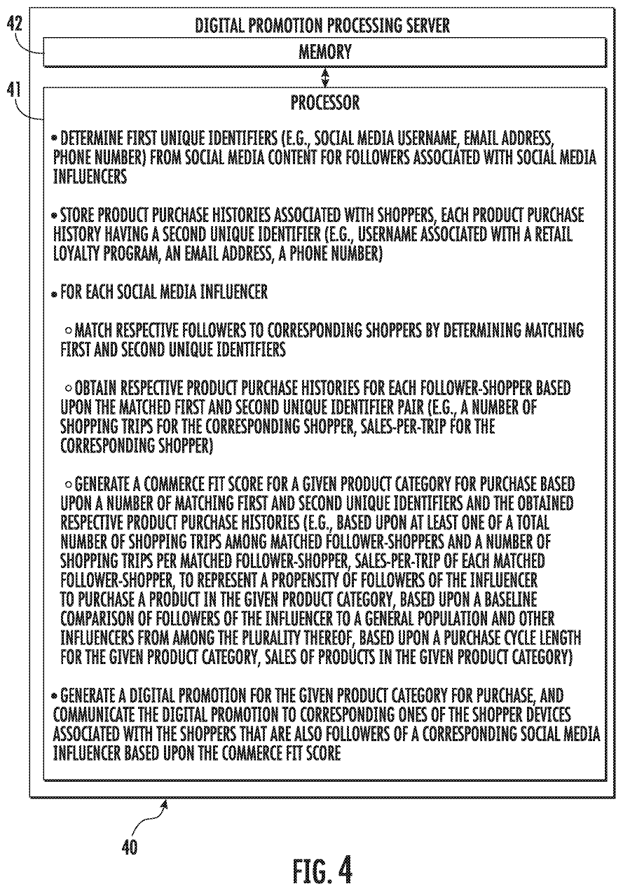

Referring initially to FIGS. 1-4, a digital promotion processing system 20 may include shopper devices 30a-30n. The shopper devices 30a-30n are each illustratively in the form of a mobile wireless communications device, particularly, a smartphone. However, each shopper devices 30a-30n may be in the form of another type of device, for example, tablet computer, laptop computer, personal computer, and wearable device.

The digital promotion processing system 20 also includes a digital promotion processing server 40. The digital promotion processing server 40 includes a processor 41 and an associated memory 42. While functions of the digital promotion processing server 40 are described herein, those skilled in the art will appreciate that the processor 41 and the memory 42 cooperate to perform these functions.

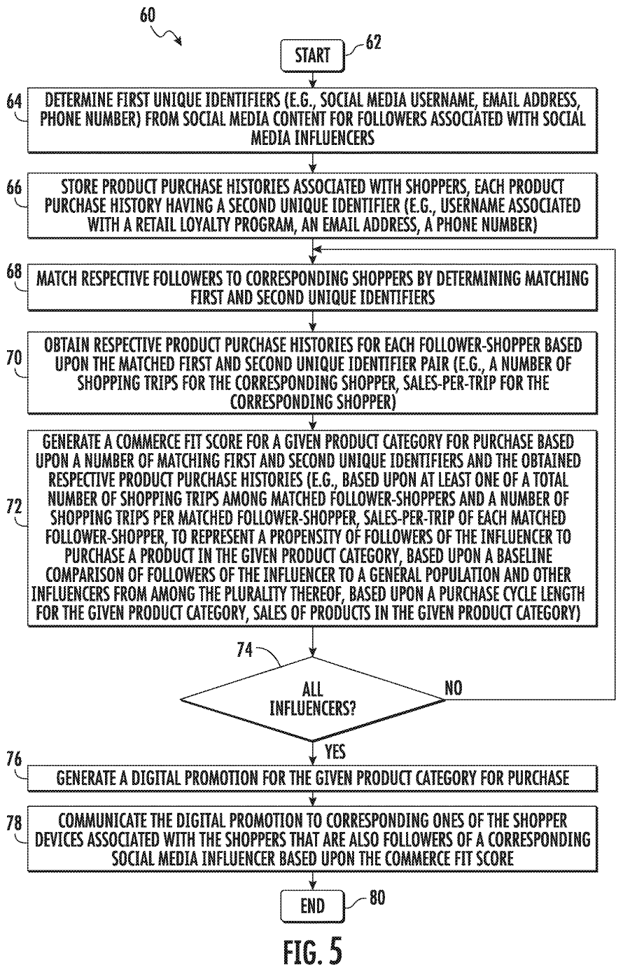

Referring now additionally to the flowchart 60 in FIG. 5, beginning at Block 62, operations of the digital promotion processing server 40 will now be described. At Block 64, the digital promotion processing server 40 determines first unique identifiers 21 from social media content 22 for followers 23a-23n associated with social media influencers 24a-24n. More particularly, a given social media influencer 24a may post social media content 22 to a social media platform. The social media content may include any one or more of text, images, links, videos, etc. For example, in some embodiments, a given social media influencer may provide a review of a given product or promote a given product or brand of products through the social media content 22. Each social media influencer 24a-24n has a username or social media handle that is used by the social media influencer on the social media platform. Each social media influencer 24a-24n may use a different username or social media handle on different social media platforms.

As will be appreciated by those skilled in the art, the followers 23a-23n may include social media users that “like” a given social media influencer 24a-24n, “follow” a given social media influencer, and/or respond to the given social media influencer with content, images, videos, etc. Each follower 23a-23n has a username or social media handle that is used by the follower on the social media platform.

The first unique identifier 21 may include one or more of a username, for example, social media username or handle, an email address, or a phone number. The first unique identifier 21 may include other and/or additional identifiers.

The digital promotion processing server 40, at Block 66, stores product purchase histories 25a-25n associated with shoppers 27a-27n. Each product purchase history 25a-25n, or shopper 27a-27n, has a second unique identifier 26 associated therewith. The second unique identifier 26 may include one or more of a username, for example, associated with a retailer or retail loyalty program, an email address, or a phone number. For example, a shopper's phone number may be associated with the shopper's loyalty program account and may be used to retrieve the shopper's product purchase history 25a-25n.

Each product purchase history 25a-25n may include a number of shopping trips 45 for the corresponding shopper. Each product purchase history 25a-25n may include a sales-per-trip 46 for the corresponding shopper. Each product purchase history 25a-25n may include quantities, descriptions, and prices paid for purchased products. Each product purchase history 25a-25n may also include times and dates of purchases, whether a promotion or coupon was applied, and/or retailer. Each product purchase history 25a-25n may include other and/or additional data regarding the shopper and the corresponding purchases. The product purchase histories 25a-25n may be obtained from point-of-sale (POS) devices at or associated with (e.g., online) one or more retailers. The product purchase histories 25a-25n may be updated as products are being purchased at the one or more retailers and communicated between the POS devices and the digital promotion processing server 40.

For each social media influencer 24a-24n, the digital promotion processing server 40 matches respective followers 23a-23n to corresponding shoppers 27a-27n by determining matching first and second unique identifier 21, 26 (Block 68). More particularly, the digital promotion processing server 40 may parse the social media content 22 associated with the corresponding social media influencer 24a-24n to determine the respective first unique shopper identifiers 21. The digital promotion processing server 40 may apply a model, for example, a text recognition model, to recognize social media usernames, email addresses, etc. that may be associated with the followers 23a-23n. Each parsed or identified first unique shopper identifier 21 may be compared to the stored second unique identifiers 26 for a match. In some embodiments, the digital promotion processing server 40 may apply translation operations to determine equivalents between the first and second unique identifiers 21, 26. For example, abbreviations, spelling variances, same words across different languages, and number-to-spelling variations may be considered equivalents.

At Block 70, for each social media influencer 24a-24n, the digital promotion processing server 40 obtains respective product purchase histories 25a-25n for each follower-shopper based upon the matched first and second unique identifiers 21, 26. The digital promotion processing server 40, for each social media influencer 24a-24n, generates a commerce fit score 43 for a given product category 44 for purchase (Block 72). The product category 44 for purchase may include groups or classes (e.g., families) of products. Exemplary product categories may include produce, dairy, baby products, meat, etc. Of course, the given product category 44 may include other and/or additional product categories, which may be broader or narrower, for example, with respect to meat, beef, poultry, etc. The product category 44 may be a single product, for example, as determined by a unique product identifier, and/or a brand of products.

The commerce fit score 43 may represent a propensity (e.g., predicted) of followers of the corresponding social media influencer 24a-24n to purchase a product in the given product category 44. In other words, the commerce fit score 43 may represent the propensity of a social media influencer's audience to buy the specific product category. More specifically, the digital promotion processing server 40 may generate the commerce fit score 43 based upon a baseline comparison of followers 23a-23n of the social media influencer 24a-24n (i.e., the given social media influencer) to a general population and other influencers from among the social media influencers.

The digital promotion processing server 40 may determine the commerce fit score 43 based upon a total number of shopping trips 45 among the matched follower-shoppers and/or a number of shopping trips per matched follower-shopper. The digital promotion processing server 40 may alternatively or additionally determine the commerce fit score 43 based upon the sales-per-trip 46 of each matched follower-shopper. The digital promotion processing server 40 may also generate the commerce fit score 43 based upon a purchase cycle length 47 for the given product category 44 (i.e., how many days between purchases of products within the same product category). The digital promotion processing server 40 may also generate the commerce fit score 43 based upon a sales of products 48 in the given product category 44. Other and/or additional data may be used by the digital promotion processing server 40 to generate the commerce fit score 43, for example, product purchase histories 25a-25n.

At Block 74, the digital promotion processing server 40 determines whether the operations performed at Blocks 68-72 have been completed for each social media influencer 24a-24n (e.g., from among the plurality of social media influencers). If the operations have not been completed for each social media influencer 24a-24n, then operations resume at Block 68 for the next social media influencer. Otherwise, operations continue at Block 76.

At Block 76, the digital promotion processing server 40 generates a digital promotion 51 for the given product category 44 for purchase. The digital promotion 51 is illustratively in the form of a digital coupon redeemable toward purchase of a product in the given product category 44. At Block 78, the digital promotion processing server 40 communicates, for example, wirelessly, the digital promotion 51 to corresponding ones of the shopper devices 30a-30n associated with the shoppers that are also followers 23a-23n of a corresponding social media influencer 24a-24n based upon the commerce fit score 43. The digital promotion 51 is illustratively displayed on the display the corresponding shopper devices 30a-30n. The corresponding shopper may provide input the respective shopper device 30a-30n to save the digital promotion 51 to a digital wallet associated with the shopper, for example, via a corresponding retailer loyalty account and application. Operations end at Block 80.

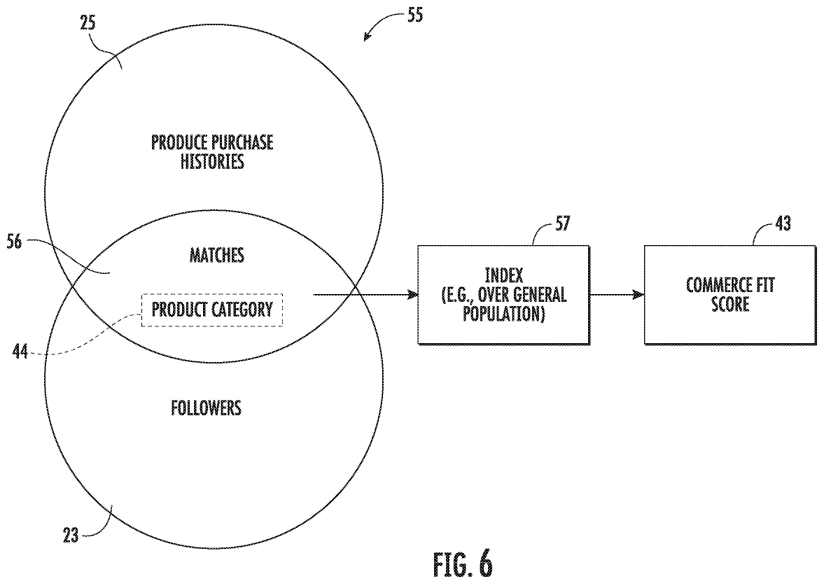

As will be appreciated by those skilled in the art, the digital promotion processing system 20 may be particularly advantageous for identifying a given social media influencer 24a-24n that may be considered a best fit for a marketing campaign or promotional campaign. More particularly, referring briefly to the diagram 55 in FIG. 6, the digital promotion processing system 20 may conceptually provide the matches 56 between product purchase histories 25 and followers 23 of a social media influencer. The matches 56 represent a retailer and product category 44 match that is used to generate an index 57 over the general population, which is thus used to generate the commerce fit score 43.

In a particular exemplary implementation, a given social media influencer 24a-24n may post social media content 22 relating to a particular brand of products for purchase or particular product for purchase. In the case of food, for example, the social media influencer 24a-24n may provide a written description of the food product and a review, along with images, locations, etc. Followers 23a-23n of the social media influencer 24a-24n typically will react to the social media content 22, for example, by posting content of their own or providing a reaction, for example, an emoji, emoticon, or other icon. Since these followers 23a-23n have a relationship to the social media influencer 24a-24n, the digital promotion processing system 20 may exploit this relationship by determining which of the followers are likely to purchase a product in the product category (e.g., food category) by matching the followers to a shopper 27a-27n (e.g., a retailer loyalty account of a shopper) and using the follower-shopper's transaction data (i.e., product purchase histories 25a-25n).

A manufacturer, retailer, or other issuer of a digital promotion may use this likelihood or propensity, in the form of a commerce fit score 43, to select a best one or best ones of the social media influencers 24a-24n for the digital promotion 51. In other words, a best fit social media influencer 24a-24n may be selected such that the selected social media influencer drives or has a highest number of shoppers 27a-27n purchasing in the product category in the social media influencer's audience (i.e., followers).

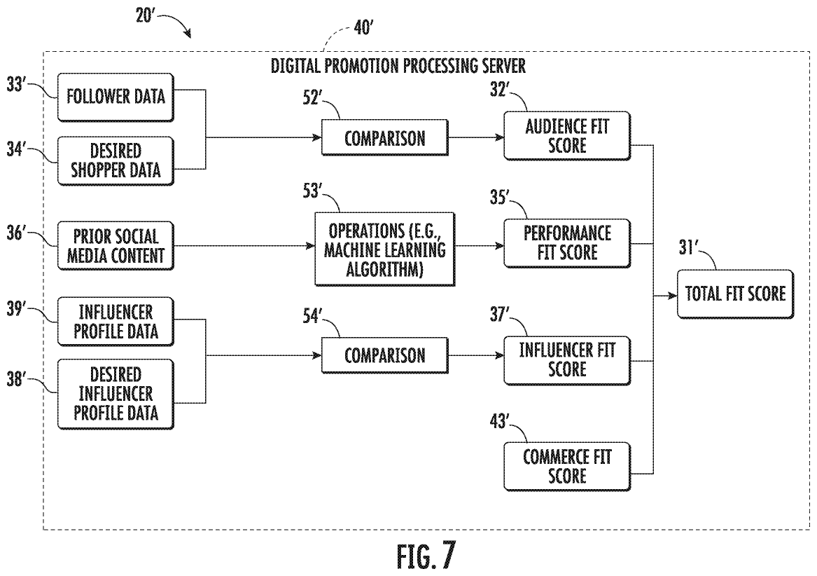

Referring now to FIG. 7, in another embodiment, the digital promotion processing system 20′ may use the commerce fit score 43′ to generate an overall or total fit score 31′. More particularly, the digital promotion processing server 40′ may generate an audience fit score 32′. The digital promotion processing server 40′ may obtain and store follower data 33′ associated with the followers of a given social media influencer. The follower data 33′ may conceptually be considered audience data and may include demographic data about those followers. Desired shopper data 34′ may also be obtained and stored by the digital promotion processing server 40′. The desired shopper data 34′ may be provided by a retailer, manufacturer, or otherwise associated with a digital promotion or promotional campaign and may represent the desired audience (e.g., in terms of demographics).

The digital promotion processing server 40′ may compare the desired shopper data 34′ and the follower data 33′ (comparison 52′) to generate the audience fit score 32′. The audience fit score 32′ may be generated similarly to the commerce fit score, described above, and/or via operation of a machine learning algorithm.

The digital promotion processing server 40′ may also generate a performance fit score 35′ based upon prior social media content 36′. The performance fit score 35′ may conceptually be considered a representation of how well the prior social media content 36′ was received by the followers and a measure of how those follows translate to shoppers, i.e., whether those followers become shoppers and purchase a product associated with the social media content. The digital promotion processing server 40′ may operate an algorithm or perform operations 53′, for example, based upon promotion redemption data and corresponding sales data to determine the performance fit score 35′.

The digital promotion processing server 40′ may also generate a creator or influencer fit score 37′. The influencer fit score 37′ is generated based upon desired influencer profile data 38′. Desired influencer profile data 38′ may include demographic and categorical data about the social media influencer, for example, gender, age, interests, etc. The digital promotion processing server 40′ compares the desired influencer profile data 38′ (comparison 54′) to influencer profile data 39′ associated with the social media influencer. Based upon matching, for example, a degree of matching, the digital promotion processing server 40′ may generate the influencer fit score 37′. The digital promotion processing server 40′ generates the total fit score 31′ based upon the audience fit score 32′, the performance fit score 35′, the influencer fit score 37′, and the commerce fit score 43′. The digital promotion processing server 40′ may generate the total fit score 31′ based upon weighting of the individual fit scores or other techniques, for example, operation of a machine learning algorithm that accepts the individual fit scores.

Actual performance and other data, as it becomes available and is obtained, may be used to train the machine learning algorithm as the overall data set becomes larger. Exemplary operations, for example, in terms of scoring, that may be performed by the digital promotion processing server 40′ are described in U.S. Pat. No. 11,042,896, the entire contents of which are herein incorporated by reference.

A method aspect is directed to a method of processing a digital promotion. The method includes using a digital promotion processing server 40 to determine a plurality of first unique identifiers 21 from social media content 22 for followers 23a-23n associated with a plurality of social media influencers 24a-24n, and store a plurality of product purchase histories 25a-25n associated with a plurality of shoppers 27a-27n. Each product purchase history 25a-25n has second unique identifier 26 associated therewith. The method also includes using the digital promotion processing server 40 to, for each social media influencer 24a-24n of the plurality thereof, match respective followers 23a-23n to corresponding shoppers 27a-27n by determining matching first and second unique identifiers 21, 26, obtain respective product purchase histories 25a-25n for each follower-shopper based upon the matched first and second unique identifier pair, and generate a commerce fit score 43 for a given product category 44 for purchase based upon a number of matching first and second unique identifiers and the obtained respective product purchase histories. The method further includes using the digital promotion processing server 40 to generate a digital promotion 51 for the given product category 44 for purchase, and communicate the digital promotion to corresponding ones of a plurality of shopper devices 30a-30n associated with the shoppers 27a-27n that are also followers 23a-23n of a corresponding social media influencer 24a-24n based upon the commerce fit score 43.

A computer readable medium aspect is directed to a non-transitory computer readable medium for processing a digital promotion. The non-transitory computer readable medium includes computer executable instructions that when executed by a processor 41 cause the processor to perform operations. The operations include determining a plurality of first unique identifiers 21 from social media content 22 for followers 23a-23n associated with a plurality of social media influencers 24a-24n, and storing a plurality of product purchase histories 25a-25n associated with a plurality of shoppers. Each product purchase history 25a-25n has second unique identifier 26 associated therewith. The operations include, for each social media influencer 24a-24n of the plurality thereof, matching respective followers 23a-23n to corresponding shoppers 27a-27n by determining matching first and second unique identifiers 21, 26, obtaining respective product purchase histories 25a-25n for each follower-shopper based upon the matched first and second unique identifier pair, and generating a commerce fit score 43 for a given product category for purchase based upon a number of matching first and second unique identifiers and the obtained respective product purchase histories. The operations may also include generating a digital promotion 51 for the given product category 44 for purchase, and communicating the digital promotion to corresponding ones of a plurality of shopper devices 30a-30n associated with the shoppers 27a-27n that are also followers of a corresponding social media influencer 24a-24n based upon the commerce fit score 23.

While several embodiments have been described herein, it should be appreciated by those skilled in the art that any element or elements from one or more embodiments may be used with any other element or elements from any other embodiment or embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A digital promotion processing system comprising:
a plurality of shopper devices; and
a digital promotion processing server configured to
determine a plurality of first unique identifiers from social media content for followers associated with a plurality of social media influencers,
store a plurality of product purchase histories associated with a plurality of shoppers, each product purchase history having a second unique identifier associated therewith,
for each social media influencer of the plurality thereof,
match respective followers to corresponding shoppers by determining matching first and second unique identifiers,
obtain respective product purchase histories for each matched follower-shopper based upon the matched first and second unique identifier pair, and
generate a commerce fit score for a given product category for purchase based upon a number of matching first and second unique identifiers and the obtained respective product purchase histories; and
generate a digital promotion for the given product category for purchase, and communicate the digital promotion to corresponding ones of the plurality of shopper devices associated with the shoppers that are also followers of a corresponding social media influencer based upon the commerce fit score.

2. The digital promotion processing system of claim 1 wherein each obtained product purchase history comprises a number of shopping trips for the corresponding shopper; and
wherein the digital promotion processing server is configured to generate the commerce fit score, for each social media influencer, based upon at least one of a total number of shopping trips among the matched follower-shoppers, and a number of shopping trips per matched follower-shopper.

3. The digital promotion processing system of claim 1 wherein each obtained product purchase history comprises a sales-per-trip for the corresponding shopper; and wherein the digital promotion processing server is configured to generate the commerce fit score, for each social media influencer, based upon the sales-per-trip of each matched follower-shopper.

4. The digital promotion processing system of claim 1 wherein the digital promotion processing server is configured to generate the commerce fit score to represent a propensity of followers of the social media influencer to purchase a product in the given product category.

5. The digital promotion processing system of claim 1 wherein the digital promotion processing server is configured to generate the commerce fit score for the given social media influencer based upon a baseline comparison of followers of the social media influencer to a general population and other social media influencers from among the plurality thereof.

6. The digital promotion processing system of claim 1 wherein the digital promotion processing server is configured to generate the commerce fit score based upon a purchase cycle length for the given product category.

7. The digital promotion processing system of claim 1 wherein the digital promotion processing server is configured to generate the commerce fit score based upon sales of products in the given product category.

8. The digital promotion processing system of claim 1 wherein the first unique identifier comprises at least one of a social media username, an email address, and a phone number.

9. The digital promotion processing system of claim 1 wherein the second unique identifier comprises at least one of a username associated with a retail loyalty program, an email address, and a phone number.

10. A digital promotion processing server comprising:
a processor and an associated memory configured to
determine a plurality of first unique identifiers from social media content for followers associated with a plurality of social media influencers,
store a plurality of product purchase histories associated with a plurality of shoppers, each product purchase history having a second unique identifier associated therewith,
for each social media influencer of the plurality thereof,
match respective followers to corresponding shoppers by determining matching first and second unique identifiers,
obtain respective product purchase histories for each matched follower-shopper based upon the matched first and second unique identifier pair, and
generate a commerce fit score for a given product category for purchase based upon a number of matching first and second unique identifiers and the obtained respective product purchase histories; and
generate a digital promotion for the given product category for purchase, and communicate the digital promotion to corresponding ones of a plurality of shopper devices associated with the shoppers that are also followers of a corresponding social media influencer based upon the commerce fit score.

11. The digital promotion processing server of claim 10 wherein each obtained product purchase history comprises a number of shopping trips for the corresponding shopper; and wherein the processor is configured to generate the commerce fit score, for each social media influencer, based upon at least one of a total number of shopping trips among the matched follower-shoppers, and a number of shopping trips per matched follower-shopper.

12. The digital promotion processing server of claim 10 wherein each obtained product purchase history comprises a sales-per-trip for the corresponding shopper; and wherein the processor is configured to generate the commerce fit score, for each social media influencer, based upon the sales-per-trip of each matched follower-shopper.

13. The digital promotion processing server of claim 10 wherein the processor is configured to generate the commerce fit score to represent a propensity of followers of the social media influencer to purchase a product in the given product category.

14. The digital promotion processing server of claim 10 wherein the processor is configured to generate the commerce fit score for the given social media influencer based upon a baseline comparison of followers of the social media influencer to a general population and other social media influencers from among the plurality thereof.

15. The digital promotion processing server of claim 10 wherein the processor is configured to generate the commerce fit score based upon a purchase cycle length for the given product category.

16. A method of processing a digital promotion comprising:
using a digital promotion processing server to
determine a plurality of first unique identifiers from social media content for followers associated with a plurality of social media influencers,
store a plurality of product purchase histories associated with a plurality of shoppers, each product purchase history having a second unique identifier associated therewith,
for each social media influencer of the plurality thereof,
match respective followers to corresponding shoppers by determining matching first and second unique identifiers,
obtain respective product purchase histories for each matched follower-shopper based upon the matched first and second unique identifier pair, and
generate a commerce fit score for a given product category for purchase based upon a number of matching first and second unique identifiers and the obtained respective product purchase histories; and
generate a digital promotion for the given product category for purchase, and communicate the digital promotion to corresponding ones of a plurality of shopper devices associated with the shoppers that are also followers of a corresponding social media influencer based upon the commerce fit score.

17. The method of claim 16 wherein each obtained product purchase history comprises a number of shopping trips for the corresponding shopper; and wherein using the digital promotion processing server to generate the commerce fit score comprises using the digital promotion processing server to generate the commerce fit score, for each social media influencer, based upon at least one of a total number of shopping trips among the matched follower-shoppers, and a number of shopping trips per matched follower-shopper.

18. The method of claim 16 wherein each obtained product purchase history comprises a sales-per-trip for the corresponding shopper; and wherein using the digital promotion processing server to generate the commerce fit score comprises using the digital promotion processing server to generate the commerce fit score, for each social media influencer, based upon the sales-per-trip of each matched follower-shopper.

19. The method of claim 16 wherein using the digital promotion processing server to generate the commerce fit score comprises using the digital promotion processing server to generate the commerce fit score to represent a propensity of followers of the social media influencer to purchase a product in the given product category.

20. The method of claim 16 wherein using the digital promotion processing server to generate the commerce fit score comprises using the digital promotion processing server to generate the commerce fit score for the given social media influencer based upon a baseline comparison of followers of the social media influencer to a general population and other social media influencers from among the plurality thereof.

21. The method of claim 16 wherein using the digital promotion processing server to generate the commerce fit score comprises using the digital promotion processing server to generate the commerce fit score based upon a purchase cycle length for the given product category.

22. A non-transitory computer readable medium for processing a digital promotion, the non-transitory computer readable medium comprising computer executable instructions that when executed by a processor cause the processor to perform operations comprising:
determining a plurality of first unique identifiers from social media content for followers associated with a plurality of social media influencers;
storing a plurality of product purchase histories associated with a plurality of shoppers, each product purchase history having a second unique identifier associated therewith;
for each social media influencer of the plurality thereof,
matching respective followers to corresponding shoppers by determining matching first and second unique identifiers,
obtaining respective product purchase histories for each matched follower-shopper based upon the matched first and second unique identifier pair, and
generating a commerce fit score for a given product category for purchase based upon a number of matching first and second unique identifiers and the obtained respective product purchase histories; and
generating a digital promotion for the given product category for purchase, and communicating the digital promotion to corresponding ones of a plurality of shopper devices associated with the shoppers that are also followers of a corresponding social media influencer based upon the commerce fit score.

23. The non-transitory computer readable medium of claim 22 wherein each obtained product purchase history comprises a number of shopping trips for the corresponding shopper; and wherein the operations comprise generating the commerce fit score, for each social media influencer, based upon at least one of a total number of shopping trips among the matched follower-shoppers, and a number of shopping trips per matched follower-shopper.

24. The non-transitory computer readable medium of claim 22 wherein each obtained product purchase history comprises a sales-per-trip for the corresponding shopper; and wherein the operations comprise generating the commerce fit score, for each social media influencer, based upon the sales-per-trip of each matched follower-shopper.

25. The non-transitory computer readable medium of claim 22 wherein the operations comprise generating the commerce fit score for the given social media influencer based upon a baseline comparison of followers of the social media influencer to a general population and other social media influencers from among the plurality thereof.
